(19) United States
(12) Patent Application Publication
(10) Pub. No.: US 2008/0007018 A1
(43) Pub. Date: Jan. 10, 2008

(54) Texture for skateboard deck and method of making

(76) Inventor: Bradford Ernest Horn, Dana Point, CA (US)

Correspondence Address: ERIC HANSCOM, 7395 PORTAGE WAY, CARLSBAD, CA, 92011, US

(21) Appl. No.: 11/480,735

(22) Filed: Jul. 5, 2006

(51) Int. Cl. A63C 17/00; B05D 1/12

(52) U.S. Cl. 280/11.19; 427/180

(57) ABSTRACT

A method of creating texture on a skateboard deck or surface of another object upon which it is desirable to have a texture, and toward a method of making and applying the texture to the surface of an object where a texture is desirable. The texture is created by coating the surface of the object with an adhesive through, preferably, coating the surface with a water-based adhesive, from an enclosed, pressurized container through a commercial paint sprayer. After coating the surface, a plurality of particles, preferably crushed, ground glass particles, are dispersed across the adhesive-coated surface and left to dry. After the adhesive/particle coat has dried, one or more surface coats of the same or a different adhesive may be optionally applied to more securely attach the particles to the surface and vary the texture. The method is fast, inexpensive, and provides a superior surface to that in the industry.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the fields of sports and textured surfaces, and more specifically, to a textured coating of the top of a skateboard, wake skates, kiteboards, windsurfers, surfboards, skimboards, kayak paddle grips, or other piece of equipment regularly used near water or where a user of the piece of equipment would benefit from a non-skid surface, such as sailboat, jet ski, zodiac boat, and motorboat decks, docks, bathroom tile floors, sidewalks near the ocean or other body of water, and any other potentially slippery place. The process also has applicability in the field of footwear, and in particular to the field of footwear such as wetsuit booties, aqua socks, sandals and tennis shoes which are worn around water. Finally, the process can create a desirable texture on various items used around water, such as kayak, canoe and raft paddles, sailboat parts, SCUBA parts, and other sports using items of gear in or near the water.

This invention is directed toward a texture on a skateboard deck or surface of another object upon which it is desirable to have a texture, and toward a method of making and applying the texture to the deck. The texture is created by coating the surface of the object with an adhesive, preferably water-based, such as urethane, shellac, or acrylic, through, preferably, coating the surface with the water-based adhesive from an enclosed, pressurized container such as, preferably, a commercial paint sprayer. After coating the surface, a plurality of particles, preferably a glass mix comprising crushed, beaded glass particles of varying sizes, are dispersed across the adhesive-coated surface and left to dry. After the adhesive/particle coat has dried, one or more surface coats of the same or a different adhesive may be optionally applied to more securely attach the particles to the surface and vary the texture.

There are many uses for this invention, but we shall focus upon skateboarding, as this will clearly illustrate the need for the invention and how the invention works. The sport of skateboarding began in the 1960's as an offshoot of surfing. Because skateboards can be used anywhere there are hard surfaces, such as streets and sidewalks, and are not limited to coastal areas with decent surf, it has eclipsed the popularity of surfing many times over both in terms of numbers of participants and size of the industry. As would be expected with such a developed sport, skateboards and their components have evolved over the four decades or so since the first person took the wheels off an old pair of roller skates and put them on the underside of a piece of wood.

The modern skateboard comprises several basic components, including a riding surface, or deck, usually make of an elongated piece of wood, fiberglass or some other sturdy, resilient and flexible material, four wheels with some sort of ball bearing arrangement upon which the deck and rider are transported, and two skateboard trucks, where the trucks are the devices by which the wheels are connected to the deck.

While there have been many improvements in the type of material from which the deck is made, and with the wheels and trucks, there has been little invention centered on how to create a deck surface which provides traction for the user. When skateboards were invented, the rider basically stood upon a plank of wood that had been sanded smooth. 40 years later, other than the advent of using strips of grip tape on the deck of the skateboard, little had been done to give the rider of a skateboard better traction.

Improvements over the past deck textures became more and more important as advances in the rest of skateboard technology allowed skateboard riders to perform more and more technically demanding maneuvers, which, in turn, made it increasingly more difficult for the rider to be able to maintain his/her footing on the deck. As maneuvers included riding, for short periods of time, vertically, long jumps, and flipping the skateboard in revolutions both along the width and length axes of the skateboard, it became more and more useful to develop a skateboard deck which allowed a rider to maintain traction under more radical riding conditions, and at the same time to create a deck texture which was easy to apply and cost effective. This invention solves these problems in a new and unique way with new and unique materials and methods.

A similar problem has similarly affected riders of wakeboards, surfboards, and other items related to water sports, in a similar manner—as the sport has evolved and the maneuvers become more advanced, there has been a corresponding need for an advanced deck texture that allows a rider to “stick” to his/her equipment better than past methods.

Thus there has existed a long-felt need for a deck texture which is inexpensive, easy to apply, and provides superior traction.

The current invention provides just such a solution by having a method of making and applying the texture to the surface of an object where a texture is desirable. The texture is created by coating the surface of the object with a liquid compound, referred to in this application as an “adhesive”, preferably a water-based adhesive, which can be applied from an enclosed, pressurized container through a commercial paint sprayer. After coating the surface with the “adhesive”, a plurality of particles, preferably, crushed, ground and/or beaded glass particles, are dispersed across the adhesive-coated surface and left to dry. While the preferred embodiment teaches the use of crushed, ground glass particles, it is envisioned that other particles could be used, including sand, crushed plastic particles, and other substances that can either be crushed and sifted to separate out particles of a particular size, or be found naturally in a particular size. After the adhesive/glass particle coat has dried, one or more surface coats of the same or a different adhesive may be optionally applied to more securely attach the glass particles to the surface and vary the texture. The method is fast, inexpensive, and provides a superior surface to that in the industry.

### SUMMARY OF THE INVENTION

It is a principal object of the invention to provide an improved deck for a skateboard, wakeboard, surfboard, or other water-sports item.

It is another object of the invention to provide a method of making an improved deck for a skateboard, wakeboard or other water-sports item.

It is an additional object of the invention that the deck is effective, inexpensive, and easy to create.

Another object of the invention is to use a minimum of components—namely, a supply of particles, preferably crushed, beaded glass mix, and an adhesive—to create a superior textured deck.

Further objects of the invention include the flexibility of allowing for the use of a wide range of materials from which the particles can be derived, including both clear particles which will show an underlying graphic image, and colored particles which can be used as part of the decorative element of the object to be textured.

It is a further object of the invention that the sharpness or graininess of the texture may be adjusted by the number of final coats of adhesive or other compound are laid over the particles.

It is also an object of this invention that a surface textured in this manner will perform well under wet or dry conditions.

It is a final object of this invention that the process allows for the inexpensive creation of a superior, non-skid surface.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### DETAILED DESCRIPTION OF THE INVENTION

The preferred iteration of the invention is a method of making a non-skid skateboard deck with the following process:

### Step 1: Obtain a skateboard and place it deck-up on a rack, preferably, for the sake of the user's health, in a well ventilated room.

Step 2: Spray over the deck of the skateboard a thin layer of an adhesive. The adhesive is preferably contained in a pressurized tank and applied to the skateboard deck through a commercial paint sprayer or similar device. The adhesive is preferably water-based, and urethane, shellac and acrylic are particularly preferred as the adhesive.

### Step 3: Transport the skateboard deck to another location where a supply of particles, preferably ground glass, is available.

### Step 4: Apply the particles to the skateboard deck.

A preferred method involves locating an application box above the skateboard deck, where the application box has a mesh screen bottom, where the screen mesh bottom can contain one or more layers of screen mesh, and the size of the screen mesh can be varied. Using this method, the user places the skateboard deck on another rack, called the application rack, and dumps a quantity of particles, preferably ground glass, into the application box, shakes the application box one or more times, to cause a certain quantity of ground glass to percolate through the mesh screen and fall randomly upon the skateboard deck. The number of times and the intensity with which the user of the invention shakes the application box is dependant upon how rapidly the ground glass percolates through the mesh screen and how much ground glass is desired on the deck of the skateboard.

An especially preferred method involves laying the skateboard on a conveyer belt, deck up, and allowing the conveyer belt to move the skateboard deck under a mechanical applicator for a set period of time, during which the mechanical applicator applies a user-adjustable amount of particles to the skateboard deck in a relatively even manner. The machine containing the conveyor belt has, preferably a collection device which collects any particles which do not adhere to the deck of the skateboard, and then returns these particles to the application box for recycling.

Another way to vary the amount of particles dispersed on the deck of the skateboard is to vary the number of “passes” that are made with the source of ground glass over the deck.

### Step 5: Move the skateboard to a drying rack in a, preferably, temperature and moisture-controlled setting, let adhesive dry for an appropriate amount of time, preferably at least 12 hours.

### Step 6: Optionally, apply one or more additional coats of the adhesive over the particles embedded in the first layer of adhesive.

### Step 6A: Let the additional coat or coats dry overnight.

### Step 7: Optionally, sand over the adhesive to make the texture less sharp.

### Step 8: Remove the skateboard and attach the trucks and wheels, then adjust the various screws and nuts to prepare the skateboard for sale or use.

This same method of applying a textured coat to the deck of a skateboard can also be used with other objects for which a textured surface is desirable. For example, the same process can be carried out on a wakeboard or surfboard in the manufacturing shop. For wetsuit booties and other water-related footwear, the textured coat can be applied after the item is manufactured, or to the sole section of the footwear before it is cut and sewn into the final product. The process can be used for a dock, sailboat deck or other surface near or in the water for which a textured, non-skid surface is desirable by merely bringing the sources of particles and adhesive to the location and applying the adhesive by a commercial paint sprayer, followed by dispersing the particles by hand, a commercial spreader or other means, over the adhesive. The adhesive/particle mixture is then allowed to dry and can, optionally, have one or more additional layers of adhesive applied. The same additional procedures (extra coats of adhesive, sanding, etc.) can also be applied to footwear.

What I claim is:

1. A method of applying a non-skid texture to a surface of an object, comprising the steps of:
first, arrange for the surface desired to be textured to be physically close to a source of a liquid compound, referred to as an “adhesive”, which acts as a bonding agent, and apply the adhesive to the surface, second, arrange for the surface desired to be textured to be physically close to a plurality of particles,
third, apply the particles to the surface, such that an adhesive/particle mixture is created,
fourth, allow the adhesive/particle mixture to dry.

2. The method of claim 1, additionally comprising the steps of:
fifth, applying one or more coats of adhesive over the layer of adhesive applied in the first step of the method,
sixth, allowing the one or more coats of adhesive applied in step 5 to dry, where each coat of adhesive is allowed to dry before the next coat of adhesive is applied.

3. The method of claim 1, where the particles are glass which has been crushed and ground.

4. The method of claim 1, where the particles are beaded glass.

5. The method of claim 1, where the adhesive is applied by spraying the liquid from a pressurized device.

6. The method of claim 1, where the adhesive is applied by hand.

7. The method of claim 1, where the surface is on a movable object, additionally comprising a preliminary step of moving the movable object to a well-ventilated location where the surface can have adhesive applied to it in a well-ventilated location.

8. The method of claim 7, where the well-ventilated location is a room enclosed on all sides with a roof such that intrusion of dust into the adhesive is minimized, such that the surface to of the object to have adhesive applied to it receives a coat comprised of at least 99.99% adhesive.

9. The method of claim 1, additionally comprising a container of adhesive, where the container is capable of having pressure applied to it, such that the adhesive can be forced from the container with force, and additionally comprising a means of applying the adhesive to the surface, and, where the means of applying the adhesive to the surface is a commercial paint sprayer.

10. The method of claim 1, where adhesive is a water-based, acrylic urethane.

11. The method of claim 1, where the third step of applying the particles to the surface comprises the steps of locating an application box with a mesh screen bottom to the box over the surface, dumping a quantity of particles into the application box, and shaking the application box one or more times, with a force that is adjustable depending on the desired amount of particles to be dislodged, and to cause a certain quantity of particles to percolate through the mesh screen and fall randomly upon the skateboard deck.

12. The method of claim 11, where the number of times and the intensity with which the user of the invention shakes the application box is dependant upon how rapidly the ground glass percolates through the mesh screen and how much ground glass is desired on the deck of the skateboard.

13. The method of claim 11, where the object is movable and the user places the movable object on an application rack, where the adhesive is applied to the object while the object is on the application rack, and, where the mesh bottom is comprised of two or more layers of mesh screen.

14. The method of claim 1, where the surface is a surface on a movable object and the step of applying the particles to the surface comprises laying the movable on a conveyer belt, deck up, and allowing the conveyer belt to move the surface under a mechanical applicator for a set period of time, during which the mechanical applicator applies a user-adjustable amount of particles to the surface in a relatively even manner, and where the object is allowed to dry at least 12 hours.

15. The method of claim 1, where the object is a skateboard and the surface upon which the texture is to be applied is a skateboard deck.

16. The method of claim 15, additionally comprising a final step: removing the skateboard from the drying rack, attaching the trucks and wheels, adjusting the various screws and nuts, and preparing the skateboard for sale or use.

17. The method of claim 1, where the object is a surface upon which people can walk, where the surface is located near a body of water, as in the case of a sidewalk near a lake, or can be temporarily located in or near a body of water, as in a sailboat that can be transported from a house to a lake.

18. A skateboard with a non-skid texture on the deck of the skateboard, where the deck is created by the following method:
first, moving the skateboard to a well-ventilated location where the surface can a source of a liquid compound, referred to as an “adhesive”, which can act as a bonding agent and apply the adhesive to the surface,
second, arrange for the surface desired to be textured to be physically close to a source of adhesive and spray over the surface desired to be textured a thin layer of adhesive, where, the a container of adhesive, where the container is capable of having pressure applied to it, such that the adhesive can be forced from the container with force, and additionally comprising a means of applying the adhesive to the surface, the means of applying the adhesive to the surface is a commercial paint sprayer,
second, arrange for the surface desired to be textured to be physically close to a source of ground glass,
third, apply the ground glass to the surface,
fourth, allow the surface to dry,
where the well-ventilated location is a room enclosed on all sides with a roof such that intrusion of dust into the adhesive is minimized, such that the surface to have adhesive applied to it receives a coat comprised of at least 99% adhesive.

19. The method of claim 18, where the step of applying the ground glass to the surface comprises locating an application box with a mesh screen bottom to the box over the surface, dumping a quantity of ground glass into the application box, and shaking the application box one or more times, to cause a certain quantity of ground glass to percolate through the mesh screen and fall randomly upon the skateboard deck, and, where the number of times and the intensity with which the user of the invention shakes the application box is dependant upon how rapidly the ground glass percolates through the mesh screen and how much ground glass is desired on the deck of the skateboard, and, where the user places the movable object on an application rack, where the adhesive is applied to the object while the object is on the application rack.

20. The method of claim 19, where the surface is a surface on a movable object and the step of applying the ground glass to the surface comprises laying the skateboard on a conveyer belt, deck up, and allowing the conveyer belt to move the skateboard deck under a mechanical applicator for a set period of time, during which the movable on a mechanical applicator applies a user-adjustable amount of ground glass to the skateboard deck in a relatively even manner.
